(19) United States
(12) Patent Application Publication
(10) Pub. No.: US 2025/0341406 A1
(43) Pub. Date: Nov. 6, 2025

(54) WIRE BASED POSITION SENSOR

(71) Applicant: Dana Motion Systems Italia S.R.L., Reggio Emilia (IT)

(72) Inventors: MariaDomenica ROMANO, Modena (IT); Pier Paolo RINALDI, Arco (IT); Gianluigi OTERI, Reggio Emilia (IT); Luca BALBONI, Rovereto (IT)

(21) Appl. No.: 18/652,034

(22) Filed: May 1, 2024

(51) Int. Cl. G01D 5/22; G01B 7/02

(52) U.S. Cl. CPC G01D 5/2291; G01B 7/02; G01D 2205/10

(57) ABSTRACT

Methods and systems for generating a signal that is indicative of linear motion in harsh operating environments are described. In one example, signal generating electronics of a sensor are housed in an air-tight compartment to reduce a possibility of signal generation capacity degradation while mechanical components of the sensor are partially shielded from environmental conditions.

### TECHNICAL FIELD

The present disclosure relates to a sensor for measuring a distance in harsh environments.

### BACKGROUND AND SUMMARY

Construction vehicles may be equipped to carry and manipulate physical loads. Some vehicles may include a telescoping arm that allows the load to be moved up, down, toward, or away from the vehicle. It may be desirable to know the position of the telescoping arm under a variety of conditions (e.g., during power on conditions and during vehicle operation) so that stability of the vehicle may be maintained. For example, the distance that the telescoping arm is extended may affect a moment of the vehicle. Thus, the weight of a load and the distance that the arm is extended may be a basis for maintaining vehicle stability. As an example, the greater the load, the less distance that the arm may be allowed to be extended so as to maintain vehicle stability. One way to determine the distance that the telescopic arm is extended may be to extend a wire as the telescopic arm is extended. The distance that the wire is extended may correlate to a change in resistance of potentiometers that rotate as a wire is drawn out and away from a sensor. The potentiometers may be bolted to a circuit board and gears may be affixed to shafts that extend from the potentiometers. The gears may rotate as wire is drawn out from a spool as the arm is extended. However, during assembly of the potentiometer based sensor, it may be possible for the gears to move away from the potentiometers base position such that the potentiometer's zero position is offset. Additionally, the gears and the potentiometers may also allow elements from the environment (e.g., water, sand, ice, etc.) access to electric components that convert potentiometer rotation into signal that is representative of a linear distance. This may lead to sensor degradation (e.g., lost signal, in accurate signal, etc.). Therefore, it may be desirable to develop a sensor that has capacity to determine a linear distance without being affected by gears that may move during sensor assembly. Further, it may be desirable for the sensor to be less sensitive to environmental factors.

In order to address at least a portion of the abovementioned issues, the inventors herein have developed a linear distance measuring system, comprising: an air-tight compartment including a first coil, a second coil, a third coil, an intermediate cover and a cover, the intermediate cover including a cylindrical protrusion configured to receive a spool.

By housing the sensor coils in an air-tight compartment that is formed via an intermediate cover and a cover and that includes a cylindrical protrusion configured to receive a spool, it may be possible to provide the technical result of converting linear motion into a signal with a reduced possibility of signal degradation from environmental conditions. Further, a position of the coil may be detected while the spool is stationary so that a position of the spool may be determined after power has been removed from and then reapplied to the linear distance measuring system.

The present description may provide several advantages. In particular, the approach may reduce contamination of electrical components due to environmental operating conditions. Further, the approach provides for a contact-less sensor that may prove to be more reliable than potentiometer based sensors. Additionally, the sensor may be assembled with ease and without sensor offset issues.

It is to be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is an illustration of an example vehicle that includes a linear distance measuring sensor.

FIG. 2 shows a schematic diagram of sensor coils.

FIG. 3 illustrates coil locations with respect to a wire pulley for the linear distance measuring sensor.

FIG. 4 is a block diagram for the linear distance measuring sensor.

FIG. 5 is an exploded view of the linear distance measuring sensor.

FIG. 6 is a method for a linear distance measurement device.

### DETAILED DESCRIPTION

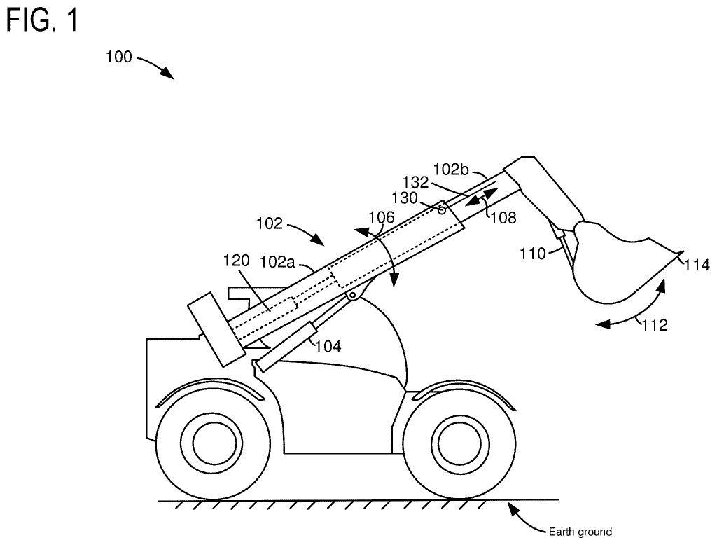

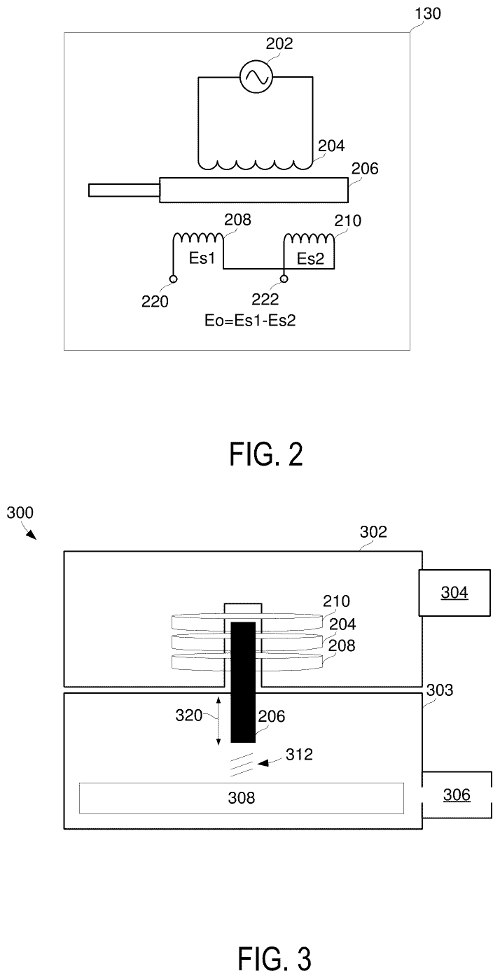

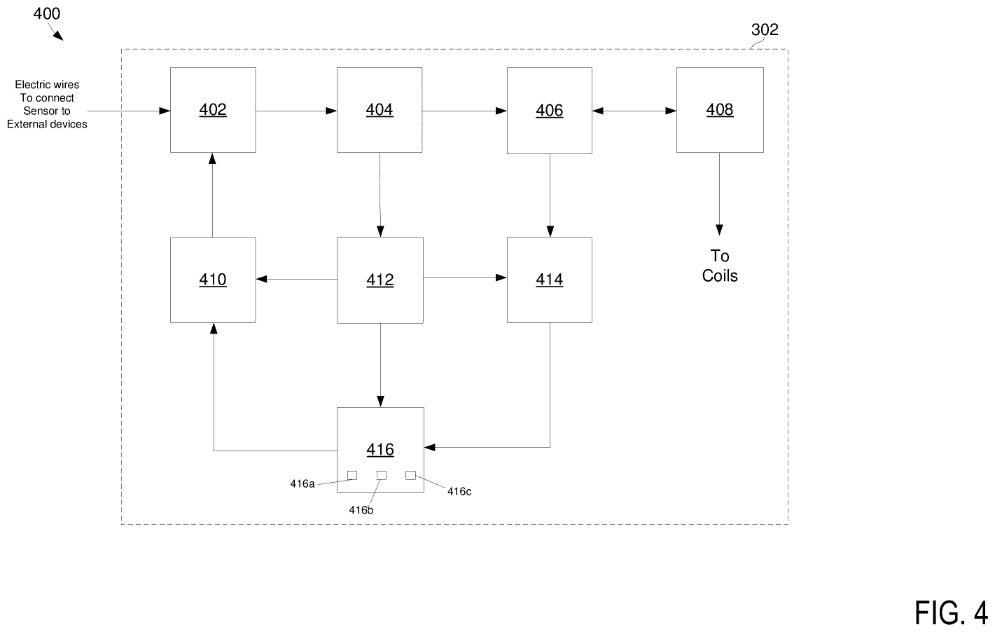

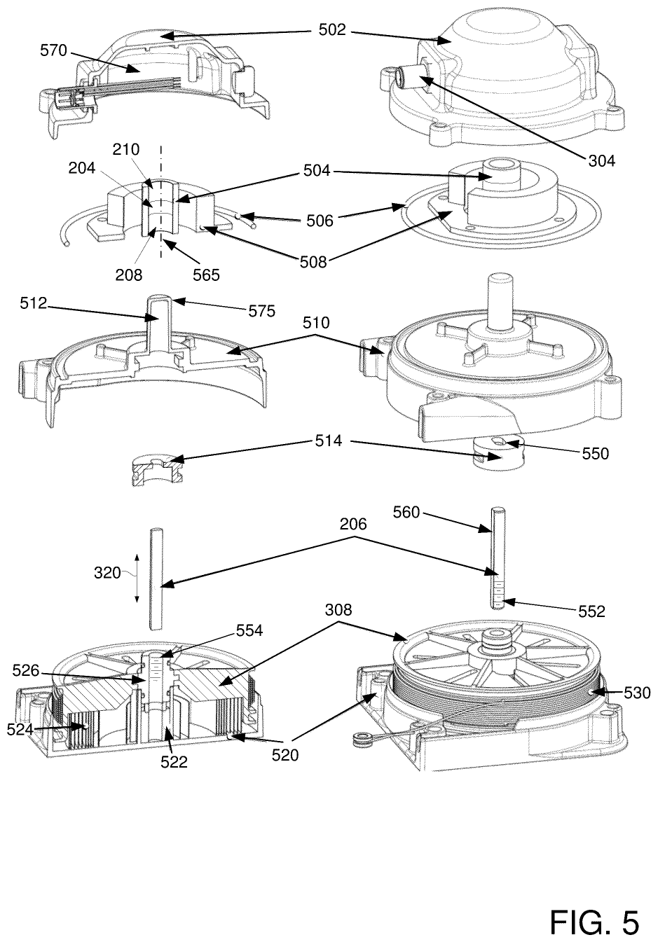

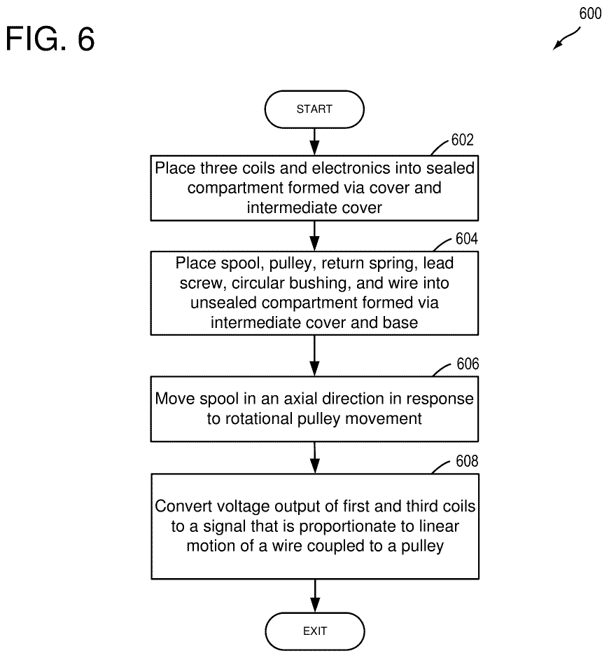

A method and system for generating a signal that is proportional to a linear distance traveled by a device are disclosed. In one example, the linear distance may be measured via a wire or cord that extends as a device (e.g., a boom or arm) extends. In still other examples, the distance that the wire or cord extends may be converted into an angular position of a device (e.g., a bucket, forks, or basket). FIG. 1 shows a non-constraining example of where a linear distance sensing device may be deployed. FIGS. 2 and 3 illustrate how coils (e.g., wire windings) of the sensor are deployed and applied. FIG. 4 shows a block diagram of example sensor components and their relation to each other. FIG. 5 shows an exploded via of an example sensor. Finally, FIG. 6 shows a flowchart of a method for a linear distance sensing device.

FIG. 1 shows an illustration of a vehicle 100 that includes an implement (e.g., a bucket) that is powered via a power source that also powers the vehicle's propulsion. In this example, vehicle 100 is configured as a wheeled loader, but in other examples vehicle 100 may be configured man lift, fork lift, excavator, back hoe, or other vehicle that includes one or more implements. The vehicle 100 may be an off-highway vehicle, in one example, although on-highway vehicles have also been envisioned. Industries and the corresponding operating environments in which vehicle 100 may be deployed include warehouses, forestry, mining, agriculture, construction, oil and gas, and the like.

Vehicle 100 is shown with a telescopic boom 102 that may extend and retract as indicated by arrows 108. Telescopic boom includes an outer arm 102a and an inner arm 102b. Inner arm 102b may slide in and out of outer arm 102a as indicated by arrows 108. Inner arm 102b may be extended or retracted as indicated by arrows 108 via hydraulic cylinder 120 (e.g., an actuator). The distance that inner arm 102b is extended may be measured via linear distance measuring sensor 130 (e.g., a linear variable displacement transducer (LVDT)). Included with linear distance measuring sensor 130 is a wire 132 that extends and retracts with inner arm 102b. The angle of telescopic boom relative to earth ground may be adjusted via hydraulic cylinder 104 (e.g., an actuator) as indicated by arrows 106. Telescopic boom 102 also includes a bucket 114. A position of bucket 114 may be adjusted as indicated by arrows 112 via hydraulic cylinder 110 (e.g., an actuator). Telescopic boom 102 may also include a second outer arm (not shown) and a second inner arm (not shown) that are configured similarly to outer arm 102a and inner arm 102b. The second outer arm and the second inner arm may be arranged in parallel with the outer arm 102a and inner arm 102b so that loads of telescopic boom 102 may be shared via the two outer arms.

Referring now to FIG. 2, a schematic diagram of coils included in the linear distance measuring sensor 130 is shown. Linear distance measuring sensor 130 includes an alternating current source 202 that is directly electrically coupled to second coil 204 (e.g., an input coil). Second coil 204 generates a magnetic field that may induce a voltage in first coil 208 (e.g., an output coil) and/or third coil 210 (e.g., an output coil) by way of spool 206. Spool 206 is comprised of a ferromagnetic material such that it may transfer magnetic flux that is generated by the second coil 204 to the first coil 208 and the third coil 210, thereby generating voltages via the first coil 208 and the third coil 210. The amount of magnetic flux that is transferred to the first coil 208 and the third coil 210 is dependent on the position of spool 206. First coil 208 is directly electrically coupled to third coil 210 and first coil 208 and third coil 210 are not electrically coupled to second coil 204. A first voltage Es1 is generated across first coil 208 and a second voltage Es2 is generated across third coil 210. The output voltage between first terminal 220 and second terminal 222 is indicated as Eo and it is the voltage difference Es1−Es2.

Moving on to FIG. 3, it illustrates coil positions within linear distance measuring sensor 130. Linear distance measuring sensor 130 includes a sealed section 302 and an unsealed section 303. Sealed section 302 is air-tight and it is formed via an intermediate cover and a cover as shown in FIG. 5. First coil 208 is directly adjacent to second coil 204 such that there are no intervening coils between first coil 208 and second coil 204. Third coil 210 is also directly adjacent to second coil 204 such that there are no intervening coils between third coil 210 and second coil 204. Spool 206 may move axially as indicated via arrow 320. Threads 312 of a lead screw may allow rotational motion of pulley 308 to be converted to linear motion in the axial direction indicated by arrow 320. A sealed electrical connector 304 allows wires to enter sealed section 302 without air entry into sealed section 302. The unsealed section includes a wire opening that allows wire to enter and exit unsealed section 303.

Referring now to FIG. 4, a block diagram 400 of a method to generate requested power for implements of a vehicle is shown. Electric wires enter sealed section 302 and terminate at electrical connector 402. Conductors carry electric power to direct current to direct current (DC/DC) converter 404. DC/DC converter 404 outputs a regulated output voltage (e.g., 5 VDC) to LVDT conditioner 406 and a low drop out regulator 412 (e.g., a voltage regulator). The low drop out regulator 412 supplies a voltage to controller area network (CAN) transceiver and pulse width modulation generator 410.

LVDT conditioner 406 provides an alternating current to the second coil 204 via electrical connector 408 and it receives a voltage output from first coil 208 and third coil 210. LVDT conditioner 406 outputs a signal (e.g., voltage or current) that is proportionate to a position of spool 206 to second order low pass filter 414. Second order low pass filter 414 outputs a low pass filtered spool position to microcontroller 416. Microcontroller 416 outputs a digital representation of a position of spool 206 to voltage to controller area network (CAN) transceiver and pulse width modulation generator 410. Microcontroller 416 includes non-transitory memory 416a for storing executable instructions, inputs 416b (e.g., digital and analog inputs), outputs 416c (digital and analog outputs). Controller area network (CAN) transceiver and pulse width modulation generator 410 outputs a signal representative of spool position to external devices via electrical connector 402.

Referring now to FIG. 5, an exploded view of linear distance measuring sensor 130 is shown. FIG. 5 shows cut-away perspective view sections of a linear distance measuring sensor components on the left side of FIG. 5 and perspective view sections of a linear distance measuring sensor on the right side of FIG. 5.

The linear distance measuring sensor includes a base 520, an intermediate cover 510, and a cover 502. The cover 502 may be fastened to the intermediate cover 510 and the base 520 via four fasteners (e.g., bolts) (not shown). Cover 502 includes an electrical connector 304 that permits signals and electric power to be transferred between external devices (not shown) and the linear distance measuring sensor. Gasket 506 may form an air-tight seal between cover 502 and intermediate cover 510. Printed circuit board 508 is also included in air-tight compartment 570, which is formed between cover 502 and intermediate cover 510 when cover 502 engages intermediate cover 510 to form an air-tight compartment 570. Printed circuit board 508 includes the components shown in the block diagram of FIG. 4. First coil 208, second coil 204, and third coil 210 are also held within air-tight compartment 570.

Intermediate cover 501 includes a protrusion 575 that passes through centers of first coil 208, second coil 204, and third coil 210 that are indicated by center line 565. Thus, protrusion 575 operates as a support for first coil 208, second coil 204, and third coil 210. Intermediate cover is blow molded over bushing 514. Bushing 514 includes a slot 550 that prevents spool 206 from rotating. However, slot 550 permits spool 206 to move in an axial direction as indicated by arrow 320. Cover 502 and intermediate cover 510 are formed of a non-ferrous material (e.g., a polymer such as plastic).

A return spring 524 is positioned between base 520 and pulley 308. The pulley 308 is clamped between the base 520 and the intermediate cover 510 so that its axial clearance is null. Return spring 524 has an inner end that is connected to the base 520 and an outer end that is connected to the pulley 308. Return spring 524 provides a force (e.g., 0.5 Newton-meters) to wind wire 530 around pulley 308. The wire may be unwound when the pulley 308 rotates counterclockwise relative to the base 520 and the intermediate cover 510. Cylindrical bushing 522 is installed to base 520 and it provides rotational and axial guidance to pulley 308. Lead screw 526 is fastened to pulley 308 and it rotates with pulley 308. Lead screw 526 includes threads 554 that interface with threads 552 of spool 206. Thus, when pulley 308 rotates, threads 554 of lead screw 526 apply force to threads 552 of spool 206 causing spool 206 to move in an axial direction as indicated by arrow 320. Milled surface 560 mates to slot 550 to form a prismatic joint, thereby preventing spool 206 from rotating as pulley 308 rotates. The dimensions of FIG. 5 are shown approximately to scale.

Thus, the system of FIGS. 1-5 provides for a linear distance measuring system, comprising: an air-tight compartment including a first coil, a second coil, a third coil, an intermediate cover and a cover, the intermediate cover including a cylindrical protrusion configured to receive a spool. In a first example, the linear distance measuring system further comprises electrical components to generate an alternating current signal and electrical components that generate a signal that is proportionate to a position of the spool. For example, the signal may be linearly or non-linearly, proportional to position of the spool. Further, the relationship may be an affine relationship. In a second example that may include the first example, the linear distance measuring system includes where the cylindrical protrusion passes through a center of the first coil, a center of the second coil, and a center of the third coil. In a third example that may include one or both of the first and second examples, the linear distance measuring system includes where the first coil is directly adjacent to the second coil. In a fourth example that may include one or more of the first through third examples, the linear distance measuring system includes where the second coil is directly adjacent to the third coil. In a fifth example that may include one or more of the first through fourth examples, the linear distance measuring system includes where the electrical components to generate the alternating current are electrically coupled to the second coil. In a sixth example that may include one or more of the first through fifth examples, the linear distance measuring system includes where the electrical components to generate the signal are electrically coupled to the first coil and the third coil. In a seventh example that may include one or more of the first through sixth examples, the linear distance measuring system includes where the cover and the intermediate cover are comprised of a polymer. In an eighth example that may include one or more of the first through seventh examples, the linear distance measuring system includes where the intermediate cover is molded over a circular bushing, and where the circular bushing includes a through hole that is aligned with a center of the cylindrical protrusion. In a ninth example that may include one or more of the first through eighth examples, the linear distance measuring system includes where the circular bushing further comprises a counter bore. In a tenth example that may include one or more of the first through ninth examples, the linear distance measuring system further comprises an electrical connector included with the cover.

The system of FIGS. 1-5 also provides for a contactless linear variable displacement transducer (LVDT) sensor system, comprising: a housing including: a sealed compartment that contains a plurality of solenoid coils that are connected to a circuit board; and an unsealed mechanical compartment that contains a spiral spring, a wire pulley, and a ferromagnetic spool that extends into a cavity side of a protrusion extending into the sealed compartment, where the spool is axially moved via rotation of the wire pulley. In a first example, the contactless LVDT sensor system includes where the plurality of solenoid coils includes a first output coil, a second input coil, and a third output coil. In a second example that may include the first example, the contactless LVDT sensor system further comprises a lead screw coupled to the wire pulley and the ferromagnetic spool. In a third example that may include one or both of the first and second examples, the contactless LVDT sensor system includes where the sealed compartment is formed via an intermediate cover and a cover. In a fourth example that may include one or more of the first through third examples, the contactless LVDT sensor system includes where the intermediate cover is molded over a bushing.

Referring now to FIG. 6, a method for a linear distance measurement device is shown. The method of FIG. 6 may be performed via a human or a machine on a vehicle assembly line. The method of FIG. 6 describes actions that may be performed in the physical world via a human or a machine. At least a portion of the actions described for the method of FIG. 6 may be performed via a controller executing instructions that have been stored in non-transitory memory of the controller. The controller may operate hardware and actuators described herein to perform the actions in the physical world.

At 602, three coils (e.g., an input coil and two output coils) and electronics (e.g., controller, LDO, DC/DC, LVDT conditions, etc. as shown in FIG. 4) are installed in an air-tight sealed compartment of a linear distance measuring sensor. The linear distance displacement sensor is formed via a cover and an intermediate cover as shown in FIG. 5. The electronics may be potted in an epoxy support structure or as a printed circuit board. Method 600 proceeds to 604.

At 604, method 600 places a spool, pulley, return spring, lead screw, circular bushing, and wire into an unsealed compartment of the linear distance measuring sensor. The unsealed compartment is formed via a base and an intermediate cover as shown in FIG. 5. Method 600 proceeds to 606.

At 606, method 600 moves the spool in an axial direction with respect to the linear distance measuring sensor in response to rotational movement of a pulley. The pulley is rotated via rolling up or unrolling wire from the pulley. The change in direction from a rotation to linear motion is performed via a lead screw and threads of a spool as shown in FIG. 5. Method 600 proceeds to 608.

At 608, method 600 converts a voltage that is generated by two coils (e.g., first and third coils as shown in FIG. 2) into a signal that is indicative of linear motion of the spool. The signal may be a digital signal or analog signal. Since the spool is coupled to the wire coming off or going on to the spool, the signal is proportionate to the distance of wire that is released from or added to the pulley. Method 600 proceeds to exit.

In this way, linear motion of a device may be tracked via movement of a wire and a signal may be generated from movement of the wire. The sensor operates on the principle of induction, so the sensor is a contactless sensor with a significant portion of the sensor able to be isolated from environmental conditions.

Thus, the method of FIG. 6 provides for a method generating a signal representative of linear motion, comprising: converting rotation of a pulley to linear motion of a spool within a cavity of an intermediate cover, where the intermediate cover and a cover form an air-tight compartment; and generating a signal according to a position of the spool. In a first example, the method includes where the signal is generated via output of a first coil and a third coil while supplying an alternating current to a second coil. In a second example that may include the first example, the method includes where a protrusion of the intermediate cover passes through the first coil, the second coil, and the third coil. In a third example that may include one or both of the first and second methods, the method includes where the second coil is positioned between the first coil and the third coil.

Note that the example control and estimation routines included herein can be used with sensor configurations. At least a portion of the control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, at least some of the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a constraining sense, because numerous variations are possible. For example, the above technology can be applied to different types of machinery. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A linear distance measuring system, comprising:
an air-tight compartment including a first coil, a second coil, a third coil, an intermediate cover and a cover, the intermediate cover including a cylindrical protrusion configured to receive a spool.

2. The linear distance measuring system of claim 1, further comprising electrical components to generate an alternating current signal and electrical components that generate a signal that is proportionate to a position of the spool.

3. The linear distance measuring system of claim 2, where the cylindrical protrusion passes through a center of the first coil, a center of the second coil, and a center of the third coil.

4. The linear distance measuring system of claim 3, where the first coil is directly adjacent to the second coil.

5. The linear distance measuring system of claim 4, where the second coil is directly adjacent to the third coil.

6. The linear distance measuring system of claim 5, where the electrical components to generate the alternating current signal are electrically coupled to the second coil.

7. The linear distance measuring system of claim 6, where the electrical components to generate the signal are electrically coupled to the first coil and the third coil.

8. The linear distance measuring system of claim 1, where the cover and the intermediate cover are comprised of a polymer.

9. The linear distance measuring system of claim 1, where the intermediate cover is molded over a circular bushing, and where the circular bushing includes a through hole that is aligned with a center of the cylindrical protrusion.

10. The linear distance measuring system of claim 9, where the circular bushing further comprises a counter bore.

11. The linear distance measuring system of claim 10, further comprising an electrical connector included with the cover.

12. A method generating a signal representative of linear motion, comprising:
converting rotation of a pulley to linear motion of a spool within a cavity of an intermediate cover, where the intermediate cover and a cover form an air-tight compartment; and
generating the signal according to a position of the spool.

13. The method of claim 12, where the signal is generated via output of a first coil and a third coil while supplying an alternating current to a second coil.

14. The method of claim 13, where a protrusion of the intermediate cover passes through the first coil, the second coil, and the third coil.

15. The method of claim 14, where the second coil is positioned between the first coil and the third coil.

16. A contactless linear variable displacement transducer sensor system, comprising:
a housing including:
a sealed compartment that contains a plurality of solenoid coils that are connected to a circuit board; and
an unsealed mechanical compartment that contains a spiral spring, a wire pulley, and a ferromagnetic spool that extends into a cavity side of a protrusion extending into the sealed compartment, where the ferromagnetic spool is axially moved via rotation of the wire pulley.

17. The contactless linear variable displacement transducer sensor system of claim 16, where the plurality of solenoid coils includes a first output coil, a second input coil, and a third output coil.

18. The contactless linear variable displacement transducer sensor system of claim 17, further comprising a lead screw coupled to the wire pulley and the ferromagnetic spool.

19. The contactless linear variable displacement transducer sensor system of claim 18, where the sealed compartment is formed via an intermediate cover and a cover.

20. The contactless linear variable displacement transducer sensor system of claim 19, where the intermediate cover is molded over a bushing.
